(19) United States
(12) Patent Application Publication
(10) Pub. No.: US 2007/0081060 A1
(43) Pub. Date: Apr. 12, 2007

(54) Inkjet printing method to alleviate bleeding

(75) Inventor: Hee-Jung Roh, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/503,241

(22) Filed: Aug. 14, 2006

(30) Foreign Application Priority Data
Oct. 10, 2005 (KR) 10-2005-0094936

(51) Int. Cl. B41J 2/17; G01D 11/00

(52) U.S. Cl. 347/96; 347/100

(57) ABSTRACT

An inkjet printing method including jetting an inkjet ink composition before and/or after a solution containing a Grignard reagent is applied to a printing medium, so that bleeding between colors of the printed image is minimized by increasing the adhesion between a colorant and a paper, and water resistance and rubbing resistance at dry and wet state for the printed image are enhanced to provide superior colorfastness.

### CROSS-REFERENCE TO RELATED APPLICATIONS

This application claims the benefit of Korean Patent Application No. 10-2005-0094936, filed on Oct. 10, 2005, in the Korean Intellectual Property Office, the disclosure of which is incorporated herein in its entirety by reference.

### BACKGROUND OF THE INVENTION 1. Field of the Invention

The present general inventive concept relates to an inkjet printing method to alleviate bleeding, and more particularly, to an inkjet printing method to minimize bleeding between colors of a printed image by applying a solution comprising a Grignard reagent before or after applying an inkjet ink composition to a printing medium, thereby increasing adhesion between a colorant and the printing medium. 2. Description of the Related Art

Generally, a material that displays an inherent color by selectively absorbing or reflecting a visible light refers to a colorant. A colorant is categorized into a dye and a pigment.

A dye to be dissolved in a solvent is dyed onto a material to be dyed, such as a fiber, a leather, a fur, a paper, etc., to give a considerable fastness to sunlight laundry, rubbing, etc. A pigment insoluble in a solvent is not directly dyed on a surface of the material to be dyed, but adheres to a surface of the material to be dyed by a physical method (e.g., adhesion), thereby displaying its inherent color.

The dye is dissolved in a solvent such as water, but the pigment is generally insoluble in the solvent. Therefore, a pigment particulate must be uniformly dispersed in a solvent so that the pigment particulate stably maintains its dispersed state without re-aggregation of the pigment particulate.

A dye type ink has very superior storage stability, maintains uniformity, and has clear color and brightness. However, the dye type ink has weak water resistance, light resistance, etc.

A pigment type ink has high optical density, superior water resistance and light resistance, and causes little bleeding between colors. However, the pigment type ink has bad clearness of colors, and low storage stability over a long period of time compared to the dye type ink. Further, a printed image by the pigment type ink has weak rubbing resistance during a dry and wet state.

Further, during color printing (multi-color printing) with the dye type ink or the pigment type ink, a bleeding phenomenon at interfaces of each color occurs, thereby deteriorating the clearness of the printed image.

In order to enhance the rubfastness and colorfastness of an ink composition by decreasing the fluidity of a colorant on a printing medium, an inkjet ink composition comprising a pigment and a water-soluble resin (see U.S. Pat. No. 5,172,133), and an inkjet ink composition comprising a certain alcohol mixture as an additive (see U.S. Pat. No. 5,529,616) have been disclosed.

However, an inkjet ink composition must maintain low viscosity since the printing type for the inkjet ink composition is a jetting type printing, and thus the inkjet ink composition must comprise a polymer binder to a minimum. However, if the amount of the binder is minimized, the binding force of the pigment particles to the printing medium is so insufficient that the colorfastness and the rubfastness of the inkjet ink composition cannot be enhanced sufficiently.

As another approach, a method of chelating a metal ion (see U.S. Pat. No. 4,694,302), a method employing a reaction between a cation and an anion (see U.S. Pat. No. 5,623,294), and a method employing a polymer reaction have been disclosed.

For the method of chelating a metal ion, the storage stability over a long period of time is not ensured due to a reaction between the metal ion contained in the ink and each ink component. For the method employing a reaction between a cation and an anion, the storage stability over a long period of time is also not ensured due to a reaction between ink components, as well as a reaction between the printing medium and ion components. In addition, for the method employing a polymer reaction, the storage stability over a long period of time is also not ensured, and furthermore, a curing apparatus and curing time for curing the polymer are required, and the method can be detrimental to the environment due to the presence of an unreacted monomer.

### SUMMARY OF THE INVENTION

The present general inventive concept provides an inkjet printing method from which storage stability over a long period of time and color fastness are improved while bleeding is decreased.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an inkjet printing method including applying a solution including a Grignard reagent represented by formula I below to a printing medium before or after applying an inkjet ink composition to the printing medium:
R₁—Mg—X I

In the formula above, R₁ represents a substituted or unsubstituted C₁-C₂₀ alkyl group, a substituted or unsubstituted C₆-C₃₀ aryl group, a substituted or unsubstituted C₁-C₂₀ heteroalkyl group, or a substituted or unsubstituted C₅-C₃₀ heteroaryl group, and X represents a halogen atom.

According to an embodiment of the present general inventive concept, the solution including the Grignard reagent represented by the formula I can be prepared by dissolving the Grignard reagent represented by the formula I in at least one organic solvent selected from a group consisting of ether, tetrahydrofuran, a monohydric alcohol and a polyhydric alcohol.

According to an embodiment of the present general inventive concept, the solution comprising the Grignard reagent represented by the formula I can include 0.1 to 20 parts by weight of the Grignard reagent represented by the formula I based on 100 parts by weight of the organic solvent.

According to an embodiment of the present general inventive concept, the Grignard reagent represented by the formula I can be applied in the amount of 10 to 100 parts by weight based on 100 parts by weight of an inkjet ink composition.

According to another embodiment of the present general inventive concept, the inkjet ink composition can include water and a colorant.

According to still another embodiment of the present general inventive concept, the colorant may be a pigment or a dye.

The foregoing and/or other aspects and utilities of the present general inventive concept are achieved by providing a printing method including applying a solution comprising a Grignard reagent represented by R₁—Mg—X to a printing medium while applying an ink composition to the printing medium, where R₁represents a substituted or unsubstituted C1-C20 alkyl group, a substituted or unsubstituted C₆-C₃₀ aryl group, a substituted or unsubstituted C₁-C₂₀ heteroalkyl group, or a substituted or unsubstituted C₅-C₃₀ heteroaryl group, and X represents a halogen atom.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An inkjet printing method according to an embodiment of the present general inventive concept includes applying a solution comprising a Grignard reagent represented by formula I below before or after applying an inkjet ink composition to a printing medium:
R₁—Mg—X I

In the formula I above, R₁ represents a substituted or unsubstituted C₁-C₂₀ alkyl group, a substituted or unsubstituted C₆-C₃₀ aryl group, a substituted or unsubstituted C₁-C₂₀ heteroalkyl group, or a substituted or unsubstituted C₅-C₃₀ heteroaryl group, and X represents a halogen atom.

R₁ may be a C₁-C₂₀ alkyl group, a C₆-C₃₀ aryl group, a C₅-C₂₀ heteroalkyl group, or a C₆-C₂₀ heteroaryl group. Particularly, R₁ may be an ethyl group or a phenyl group.

In the formula I above, X may be F, Cl, Br, I or At.

The Grignard reagent reacts with a colorant of an inkjet ink composition to enhance a property of fusing the ink on a printing medium. The Grignard reagent can be prepared by a Grignard reaction between magnesium and an alkyl(aryl) halide compound or a heteroalkyl(aryl) halide compound. Examples of the alkyl(aryl) halide include dibromoethane, and bromobenzene, etc.

The solution including a Grignard reagent can be prepared by dissolving a Grignard reagent represented by the formula I above in an organic solvent. The organic solvent may be at least one organic solvent selected from a group consisting of ether, tetrahydrofuran, a monohydric alcohol and a polyhydric alcohol, and particularly may be ether, isopropyl alcohol, or ethyl alcohol.

The solution including a Grignard reagent represented by the formula I above can be prepared by dissolving 0.1 to 20 parts by weight of a Grignard reagent in 100 parts by weight of an organic solvent. If the amount of the Grignard reagent is less than 0.1 parts by weight, the performance concerning a time for drying a recorded image, an optical density, color bleeding, water resistance, and rub resistance, etc. can be little enhanced. If the amount of the Grignard reagent exceeds 20 parts by weight, its solubility in the organic solvent can be decreased.

Magnesium is present in the form of Mg²⁺ in the Grignard compound, binds to the—OH group of cellulose constituting a paper through a strong interaction, and thus such Mg²⁺ ion binds to the R₁ group in the Grignard reagent by electrostatic attraction, thereby strongly binding a paper to the R₁ group.

A functional group such as ester group (—COO—) and carbonyl group (—C(═O)—) is also present on a surface of a colorant in an ink composition. Accordingly, the functional group reacts with the R₁ group in the Grignard compound fused on a paper surface to strengthen the adhesion to the paper.

The Grignard compound reacts with a colorant in the ink composition as follows:

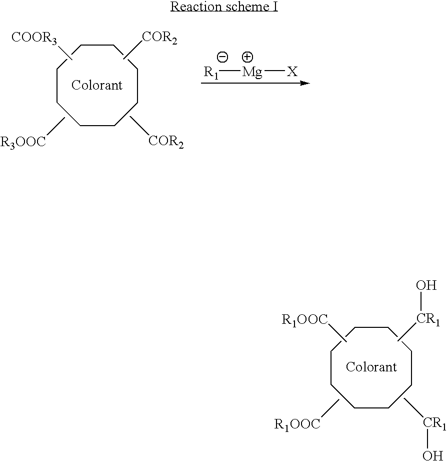

In the scheme, R₂, and R₃ are a hydrogen atom, a substituted or unsubstituted C₁˜C₂₀ alkyl group, a substituted or unsubstituted C₆˜C₂₀ aryl group, a substituted or unsubstituted C₂˜C₆ alkenyl group, nitro group, a halogen, or CN.

The solution including the Grignard reagent can be applied in the amount of 10 to 100 parts by weight of the Grignard reagent based on 100 parts by weight of an inkjet ink composition. If the amount of the Grignard reagent is less than 10 parts by weight, the effect of preventing color bleeding may be trivial. If the amount of the Grignard reagent is more than 100 parts by weight, it acts like a foreign material between an ink and a printing medium, and thus the image quality may be deteriorated.

The solution including the Grignard reagent can be applied before and/or after applying an inkjet ink composition to a printing medium.

The solution including the Grignard reagent can further include a surfactant. A surfactant controls a surface tension of the solution, thereby stabilizing a jetting performance at a nozzle. Such a surfactant may be an ionic surfactant, or a non-ionic surfactant. If a polyoxide-based material is used as the surfactant, the polyoxide-based material can function as an anti-vaporizing agent through preventing clogging at a nozzle since the material has a similar chemical structure with a glycol-based material. The amount of the surfactant can be in a range of 0.1 to 10.0 parts by weight based on 100 parts by weight of the organic solvent. If the amount of the surfactant exceeds 10.0 parts by weight, the viscosity of the solution is excessively increased, thereby preventing jetting. If the amount of the surfactant is less than 0.1 parts by weight, the surfactant does not come into effect.

The solution including the Grignard reagent can further include a viscosity controller. A viscosity controller controls the viscosity of the solution to maintain smooth jetting, and may be, but is not limited to, any one selected from a group consisting of polyvinyl alcohol, polyvinyl pyrrolidone, polyetherimide, polyethylene glycol, casein, or carboxymethyl cellulose. The amount of the viscosity controller in the solution including the Grignard reagent may be in a range of 0.1 to 10.0 parts by weight based on 100 parts by weight of the organic solvent. If the amount of the viscosity controller exceeds 10.0 parts by weight, the viscosity of the solution is excessively increased, thereby preventing jetting. If the amount of the viscosity controller is less than 0.1 parts by weight, the viscosity controller does not come into effect.

The inkjet ink composition can further include water and a colorant.

A colorant used in an embodiment of the present general inventive may be a self-dispersible dye, a self-dispersible pigment, or a conventional pigment used with a dispersant. The amount of these colorants is 0.1 to 15% by weight, and may be 0.1 to 10% by weight, although the amount is not particularly limited. Examples of the colorant include, but are not limited to, C.I. Basic Black 2, C.I. Direct Yellow 44, C.I. Basic Blue 26, C.I. Direct Red 227, Projet Fast Cyan 2 (Zeneca Company), Projet Fast Magenta 2 (Zeneca Company), Projet Fast Yellow 2 (Zeneca Company), or Projet Fast Black 2 (Zeneca Company).

An inkjet ink composition according to an embodiment of the present general inventive concept can include an additive such as a surfactant, a pH controller, a preservative, or a chelating agent. The total amounts of the additives are 0.01 to 2 parts by weight based on 1 part by weight of a colorant.

The present general inventive concept will be described in greater detail with reference to the following examples. The following examples are for illustrative purposes only and are not intended to limit the scope of the general inventive concept. The examples below evaluated the properties for an ink composition, however, the evaluation method can also be used in evaluating a wet toner, a dry toner, a paint and/or a coating liquid. Hereinafter, an ink composition including an amide compound and a colorant will be described as a representative example, and thus the present general inventive concept is not limited to the ink composition.

### EXAMPLES

### Preparation of a Grignard Reagent

### Preparation of a Reaction Apparatus

25 mmol of magnesium were placed in a flask, and then the overall apparatus was heated for 15 minutes in a 100 degrees C. oven, or the overall flask was slightly heated by weak fire using a burner or an electric heater. The flask was continuously heated beginning from its lower part to all parts so that moisture was evaporated from the inner surface of the flask as the fire of the burner reached the flask. However, magnesium must not be heated excessively since it can be oxidized. Water vapor in the flask ascended up in the apparatus and was absorbed by a desiccant in a drying tube. The flask stood still until it cooled down to room temperature.

### Preparation Example 1

### Preparation of Ethyl Magnesium Bromide

8 ml of absolute ether, and dibromoethane (the same mols as magnesium) were placed in the flask containing magnesium, and mixed well. Air bubbles on the magnesium surface, cloudiness to grey-brown color, or a reflux of the solution were observed. If these phenomena did not appear within 2 or 3 minutes, an ice bath was then prepared.

The solution was heated in a 50 degrees C. water bath until ether boiled; and then a piece of small I₂ crystal was put in. Several droplets of dibromoethanol were dropped, and the magnesium powder in the flask was pulverized by mixing with a stirrer. Some magnesium powder was added to a test tube containing 1 ml of dibromoethane, and the magnesium powder was reacted by mixing with a stirrer. When a reaction began, the reactant was quickly poured into the flask.

### Preparation Example 2

### Preparation of Phenyl Magnesium Bromide

25 mmol of dry magnesium pieces were placed in 125˜250 ml 3-neck flask, and then the flask was heated to dry. 25 mmol of bromobenzene or iodobenzene were added to 8 ml of absolute ether, and mixed well. Then, the solution was transferred to a separatory funnel immediately, and the separatory funnel was attached to a reactor. 12 ml of absolute ether were placed in the flask containing magnesium, and then about 1 ml of bromobenzene solution was added and reacted. If a reaction was not progressed, operation was again started from preparation of a reaction apparatus. If a reaction was progressed, the bromobenzene solution was added to the reactor in a speed of reflux being maintained. After all reagents were added, the mixture was refluxed for 15 minutes in a hot water bath, and then cooled down.

For an alkyl group of which R₁ is substituted or unsubstituted, the Grignard reagent was prepared by the same method as the Preparation Example 1. For an aryl group of which R₁ is substituted or unsubstituted, the Grignard reagent was prepared by the same method as the Preparation Example 2. The results are shown in Table 1 below.

TABLE 1

| | Reagent 1 | Reagent 2 | Solvent | Product |
|---|---|---|---|---|
| S 1 | Dibromoethane | Mg | Ether | Ethylmagnesium bromide |
| S 2 | Bromobenzene | | THF | Phenylmagnesium |
| | | | | bromide |
| S 3 | Chlorobutane | | Diethylether | Buthylmagnesium |
| | | | | bromide |

The following examples used reagents listed in Table 2 below available in the Aldrich Company.

TABLE 2

| No. | Grignard reagent | Solvent | Solution |
|---|---|---|---|
| S4 | CH₃Br | 3.0 M in diethylether | Methylmagnesium bromide |
| S5 | CH₃CH₂Cl | 2.0 M in tetrahydrofuran | Ethylmagnesium chloride |
| S6 | 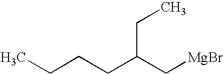 | 1.0 M in diethylether | (2-Ethylhexyl) magnesium bromide |
| S7 | 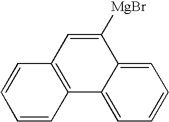 | 0.5 M in tetrahydrofuran | 9-Phenanthryl magnesium bromide |
| S8 | 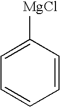 | 2.0 M in tetrahydrofuran | Phenylmagnesium chloride |

Solutions containing 5.0 g of the listed Grignard reagent (S1˜S8), 25 g of an organic solvent, 3.0 g of a surfactant (Tween 20) and 3.0 g of a viscosity controller (PEG 200) were prepared, and described as Solutions 1 to 8 including the Grignard reagent, respectively.

Ink compositions 1˜5 including the components described in Table 3 were prepared. In the table, the number in parenthesis refers to parts by weight.

TABLE 3

| No. | Colorant | Humectant | Viscosity controller | Surfactant | Water |
|---|---|---|---|---|---|
| Ink 1 | Food Black | DEG (150) | PEG 200 (150) | Surfynol 465 (25) | Deionized water (400) |
| Ink 2 | D.B 199 (100) | Glycerin (140) | PEG 300 (200) | Tween 20 (8) | Deionized water (250) |
| Ink 3 | A.Y 23 (100) | EG (180) | Casein (150) | Surfynol 485 (20) | Deionized water (250) |
| Ink 4 | C.W (Oriental) | DEG (200) | PEG 200 (150) | Tween 20 (7) | Deionized water (300) |
| Ink 5 | Cabojet 300 | Glycerin (250) | Polyvinylpyrrolidone | Tergitol (10) | Deionized water (400) |

### Examples 1 to 8

The solutions 1 to 8 including the Grignard reagents were placed in an M-50 cartridge of an MJC-3300p printer, respectively. The cartridge and a color ink cartridge C-60 in which the Inks 1 to 5 were injected were set to an inkjet printer. A printer driver having an operation of controlling jetting the solution and the color ink, respectively, was prepared, and an inkjet recording image was obtained using the printer driver.

### Comparative Examples 1 to 5

A color ink cartridge (MJC-3300p C-60) in which the inks 1 to 5 were injected without using the solution containing the Grignard reagent were applied to an inkjet printer to obtain an inkjet recording image.

### Experimental Example 1

### Storage Stability

100 ml of the solution including the Grignard reagent were stored in a heat-resistant vial. The opening of the vial was closed, and the vial was stored in an incubator to be controlled at 60 degrees C. After 2 months, it was confirmed through observation and filtering as to whether precipitates occurred. Evaluation results are shown as follows.
∘: no precipitates occurred.
X: precipitates occurred.

### Experimental Example 2

### Optical Density

Optical density of an image recorded on a general paper was determined by using an optical densitometer (RD-1235, Macbeth Company), and an average optical density was evaluated according to the following standard.
O: above 0.90
□0.75˜0.90
X: less than 0.75

### Experimental Example 3

### Color Bleeding

Solid images were printed adjacent to each other with different colors, and color bleeding at interfaces was observed and evaluated as follows.
∘: no bleeding
□: some bleeding occurred, but no problem in practical use
X: bleeding was serious

### Experimental Example 4

### Test of Water Resistance

The change of optical density before and after dipping into water was observed to investigate the degree that a colorant component is bled out into water when a printed image was dipped into water 1 hour after printing-out.
A=(OD of image after dipping into water/OD of original image)×100(%)
∘: A>90
□: 70≦A<90
X: A<70

### Experimental Example 5

### Bleeding by Rubbing

1 Hour after printed-out, the printed character and image was rubbed with a finger wearing a latex examination glove manufactured by Fisher Scientific Co. to investigate whether bleeding occurred.
∘: no bleeding
□: some bleeding occurred

X: bleeding was so serious that the character was illegible Evaluation results

TABLE 4

| | Example | | | | | | | | | | | | | | | |
|---|---|---|---|---|---|---|---|---|---|---|---|---|---|---|---|---|
| | 1 | | 2 | | 3 | | 4 | | 5 | | 6 | | 7 | | 8 | |
| Ex.* | S1 | Ink 1 | S2 | Ink 2 | S3 | Ink 3 | S4 | Ink 4 | S5 | Ink 5 | S6 | Ink 2 | S7 | Ink 3 | S8 | Ink 5 |
| 1 | ◯ | ◯ | ◯ | ◯ | ◯ | ◯ | ◯ | ◯ | ◯ | ◯ | ◯ | ◯ | ◯ | ◯ | ◯ | ◯ |

| | | | | | | | | |
|---|---|---|---|---|---|---|---|---|
| 2 | ◯ | ◯ | Δ | ◯ | ◯ | ◯ | ◯ | ◯ |
| 3 | ◯ | ◯ | ◯ | ◯ | ◯ | ◯ | Δ | ◯ |
| 4 | Δ | Δ | ◯ | ◯ | ◯ | ◯ | Δ | ◯ |
| 5 | ◯ | ◯ | ◯ | Δ | Δ | ◯ | ◯ | Δ |

| | Comparative Example | | | | |
|---|---|---|---|---|---|
| | 1 | 2 | 3 | 4 | 5 |
| Ex.* | Ink 1 | Ink 2 | Ink 3 | Ink 4 | Ink 5 |
| 2 | Δ | ◯ | X | ◯ | ◯ |
| 3 | X | X | X | Δ | ◯ |
| 4 | X | Δ | X | ◯ | ◯ |
| 5 | ◯ | ◯ | ◯ | X | X |

“*” denotes to Experimental Example.

The inkjet printing method according to the present general inventive concept improves the image quality and the durability of a printed image by jetting an inkjet ink composition before and/or after a solution containing a Grignard reagent is applied to a printing medium, so that bleeding between colors of the printed image is minimized by increasing the adhesion between a colorant and a paper, and water resistance and rubbing resistance at dry and wet states for the printed image are enhanced to provide superior colorfastness.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printing method comprising:
applying a solution comprising a Grignard reagent represented by formula I below to a printing medium before or after applying an inkjet ink composition to the printing medium:
R₁—Mg—X I
where R₁ represents a substituted or unsubstituted C₁-C₂₀ alkyl group, a substituted or unsubstituted C₆-C₃₀ aryl group, a substituted or unsubstituted C₁-C₂₀ heteroalkyl group, or a substituted or unsubstituted C₅-C₃₀ heteroaryl group, and X represents a halogen atom.

2. The inkjet printing method of claim 1, wherein the solution is prepared by dissolving the Grignard reagent represented by formula I in at least one organic solvent selected from the group consisting of ether, tetrahydrofuran, a monohydric alcohol and a polyhydric alcohol.

3. The inkjet printing method of claim 2, wherein the solution is prepared by dissolving 0.1 to 20 parts by weight of the Grignard reagent represented by formula I based on 100 parts by weight of the organic solvent.

4. The inkjet printing method of claim 1, wherein the solution comprising the Grignard reagent is applied in the amount of 10 to 100 parts by weight of the Grignard reagent based on 100 parts by weight of the inkjet ink composition.

5. The inkjet printing method of claim 1, wherein the inkjet ink composition comprises water and a colorant.

6. The inkjet printing method of claim 5, wherein the colorant is a pigment or a dye.

7. The inkjet printing method of claim 1, wherein R₁ is a C₁-C₂₀ alkyl group, a C₆-C30 aryl group, a C₅-C₂₀ heteroalkyl group, or a C₆-C₂₀ heteroaryl group.

8. The inkjet printing method of claim 1, wherein X is F, Cl, Br, I or At.

9. The inkjet printing method of claim 1, wherein the Grignard reagent is prepared by a Grignard reaction between magnesium and an alkyl(aryl) halide compound or a heteroalkyl(aryl) halide compound.

10. The inkjet printing method of claim 1, wherein the Grignard reagent is applied in the amount of 10 to 100 parts by weight of the Grignard reagent based on 100 parts by weight of an inkjet ink composition.

11. The inkjet printing method of claim 1, wherein the solution including the Grignard reagent further includes a surfactant.

12. The inkjet printing method of claim 11, wherein the surfactant is an ionic surfactant.

13. The inkjet printing method of claim 11, wherein the surfactant is a non-ionic surfactant.

14. The inkjet printing method of claim 11, wherein the amount of the surfactant is in the range of 0.1 to 10.0 parts by weight based on 100 parts by weight of the organic solvent.

15. The inkjet printing method of claim 2, wherein the solution including the Grignard reagent further includes a viscosity controller.

16. The inkjet printing method of claim 15, wherein the viscosity controller selected from a group consisting of polyvinyl alcohol, polyvinyl pyrrolidone, polyetherimide, polyethylene glycol, casein, or carboxymethyl cellulose.

17. The inkjet printing method of claim 15, wherein the viscosity controller in the solution including the Grignard reagent may be in a range of 0.1 to 10.0 parts by weight based on 100 parts by weight of the organic solvent.

18. The inkjet printing method of claim 5, wherein the inkjet ink composition includes an additive from a group consisting of a surfactant, a pH controller, a preservative, or a chelating agent.

19. The inkjet printing method of claim 18, wherein the total amount of the additive is about 0.01 to 2 parts by weight based on about 1 part by weight of a colorant.

20. A printing method comprising:
applying a solution comprising a Grignard reagent represented by R₁—Mg—X to a printing medium while applying an ink composition to the printing medium,
where R₁ represents a substituted or unsubstituted C₁-C₂₀ alkyl group, a substituted or unsubstituted C₆-C₃₀ aryl group, a substituted or unsubstituted C₁-C₂₀ heteroalkyl group, or a substituted or unsubstituted C₅-C₃₀ heteroaryl group, and X represents a halogen atom.
